(19) United States
(12) Patent Application Publication
(10) Pub. No.: US 2011/0163700 A1
(43) Pub. Date: Jul. 7, 2011

(54) METHODS AND SYSTEMS RELATED TO DESULFATION OF A BATTERY

(75) Inventor: Billy R. Masten, Shallowater, TX (US)

(73) Assignee: PUTTING AROUND, INC., Midland, TX (US)

(21) Appl. No.: 12/984,141

(22) Filed: Jan. 4, 2011

Related U.S. Application Data
(60) Provisional application No. 61/292,623, filed on Jan. 6, 2010.

(51) Int. Cl. H02P 7/00

(52) U.S. Cl. 318/139

(57) ABSTRACT

Desulfation of a battery. At least some of the illustrative embodiments are methods of inducing ringing across terminals of a battery to reduce and/or reverse the build up sulfate crystals on the battery plates.

### CROSS-REFERENCE TO RELATED APPLICATIONS

This application claims the benefit of Provisional Application Ser. No. 61/292,623, filed Jan. 6, 2010, titled “Motor control system”, which application is incorporated by reference herein as if reproduced in full below.

### BACKGROUND

Battery operated vehicles have been available for many years. Though there are many different types of batteries that may be used in such vehicles, for vehicles not intended for highway speeds (e.g., for golf carts) the lead-acid battery has been the battery of choice because of relatively low cost, high current producing capability, and high availability. However, lead-acid batteries have relatively limited life spans. For example, lead-acid batteries in golf carts have a life span of about three years.

The limited life span of lead-acid batteries in golf carts is believed to be due to the build up of lead sulfate on the battery plates. In particular, during discharge lead sulfate builds on the electrodes, and during charging the sulfate is driven off the plates (to form sulfuric acid in the electrolyte). However, the process is not one hundred percent efficient—a small portion of the lead sulfate created during each discharge may not reverse during the next charge. Moreover, with time lead sulfate turns to a crystalline form, which does not conduct and cannot be easily converted back to non-crystalline form. Thus, either by leaving the lead-acid battery in a discharged state for extended periods, or many charge-discharge cycles, the electrodes become coated with crystalline lead sulfate and become unusable.

### BRIEF DESCRIPTION OF THE DRAWINGS

For a detailed description of exemplary embodiments, reference will now be made to the accompanying drawings in which:

FIG. 1 shows a schematic of a control system in accordance with at least some embodiments;

FIG. 2 shows a plurality of time-based signals in accordance with at least some embodiments;

FIG. 3 shows a schematic of a control system in accordance with at least some embodiments;

FIG. 4 shows a plot of battery voltage as a function of time in accordance with at least some embodiments;

FIG. 5 shows a plurality of time-based signals in accordance with at least some embodiments;

FIG. 6 shows a control system in accordance with at least some embodiments;

FIG. 7 shows a plot a battery voltage as a function of time in accordance with at least some embodiments;

FIG. 8 shows a method in accordance with at least some embodiments; and

FIG. 9 shows a method in accordance with at least some embodiments

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

“Cycle” shall mean, with respect to a pulse-width-modulated signal, a period of time spanning a leading edge of a first asserted state to a leading edge of a second asserted state immediately subsequent to the first asserted state, the first and second asserted states separated by a non-asserted state.

“Asserted state” shall mean the state of a Boolean signal that forces a transistor to a conductive state. An asserted state may be asserted with high voltage or asserted with low voltage.

“Minimum off time” shall mean a length of time of a non-asserted state within a cycle. A non-asserted state may be longer than the minimum off time within a cycle, but not shorter.

“Short circuit” shall mean that a resistance experienced across the terminals of a battery is less than 0.20 Ohms, and wherein the resistance does not include winding resistance of an electric motor.

“Battery” shall mean a plurality of battery cells coupled in a series and/or in a parallel configuration. Thus, the term “battery” comprises not only the cells within a single housing, but also situations where a plurality of cells are disposed within a plurality of housings.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to methods and related systems of extending the life of lead-acid batteries. The methods and systems were developed in the context of battery-operated vehicles, and in particular golf carts, and thus the description that follows is based on the developmental context. However, the methods and systems find application in any situation where lead-acid batteries are used, and thus the developmental context shall not be construed as a limitation as to the applicability of the various embodiments.

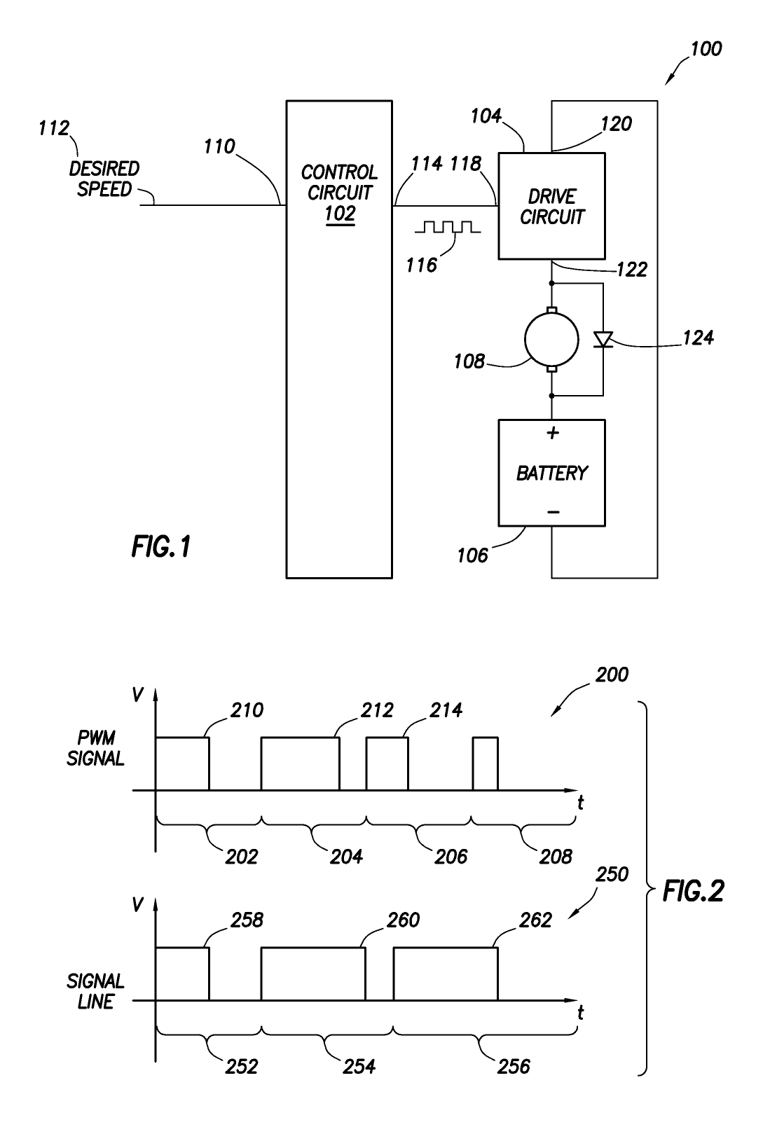

FIG. 1 illustrates a direct-current (DC) electric motor control system 100 in accordance with at least some embodiments. In particular, the control system 100 comprises a control circuit 102, a drive circuit 104, a battery 106, and a DC electric motor 108. In use, the drive circuit 104 controls the electrical current flow from battery 106 (e.g., three 12 volt lead-acid batteries connected in series) through the DC electrical motor 108. Speed of the electrical motor 108 is controlled by the control circuit 102 based on a desired speed indication 112 provided to the control circuit 102. So as not to unduly complicate the figure, the control system 100 of FIG. 1 is shown as an open loop control system, meaning no motor speed feedback is provided to the control circuit 102. In other embodiments, many feedback parameters may be provided to the control circuit, such as motor speed, motor temperature and instantaneous electrical current draw.

The control circuit 102 defines an input lead 110 that accepts the desired speed indication 112. The desired speed indication 112 may be derived from any of a variety of devices. For example, in some embodiments the desired speed indication 112 may be derived from a driver pressing an accelerator on a golf cart. Displacement of the accelerator may be detected by any suitable mechanism, such as an optical system described in U.S. Pat. No. 5,896,487. Other detecting mechanisms, such as a rheostat coupled to the accelerator, may be equivalently used. In yet still other embodiments, the desired speed signal 112 applied to the input lead 110 may be provided from an upstream electronic device. The control circuit 102 further defines an output lead 114 upon which is driven a pulse-width modulated output signal 116. In particular, the control circuit 102 drives the pulse-width modulated output signal 116 proportional to the desired speed indication 112. In a particular embodiment, the control circuit 102 implements a minimum off time with the respect to the pulse-width modulated output signal 116, which minimum off time is discussed more thoroughly below.

Control circuit 102 may take many forms. In some embodiments the control circuit 102 is an analog control circuit, where control signals sent to the drive circuit 104 are generated by discrete components based on the desired speed and an internal reference, such as oscillator. In other embodiments, the control circuit 102 is a processor, application specific integrated circuit (ASIC), or microcontroller executing a program. The program reads the desired speed and creates one or more output signals which are provided to the drive circuit 104. In yet still other embodiments, combinations of processor-based control and analog-based control are used.

Drive circuit 104 defines a control input lead 118, as well as a first lead 120 and a second lead 122. As shown the control input lead 118 couples to the output lead 114, and thus the pulse-width modulated signal 116. In some embodiments, the drive circuit 104 comprises one or more metal oxide semiconductor field effect transistors (MOSFETs). The specific type and number of such MOSFETs depends on a variety of factors, such as the peak current and the switching frequency. For golf cart operations, four N-Channel MOSFETs having part number IRF540 (available from SGS-Thomson Microelectronics of Port Jefferson Station, N.Y.) connected in parallel provide sufficient current carrying capability. However, greater or fewer MOSFETs, different types of MOSFETs, different types of transistors (e.g., junction transistors) may be equivalently used.

In accordance with various embodiments, the speed of the electric motor 108 is controlled by the effective or time averaged conductivity of the drive circuit 104. In some embodiments, the switching devices (e.g., MOSFETs) of the drive circuit 104 are, as a group, alternately driven between a fully-saturated conductive state and non-conductive state responsive to the pulse-width modulated signal 116 applied to the control input lead 118. During periods of time when the drive circuit 104 is conductive, electrical current flows from the battery 106, through the electric motor 108, through the drive circuit 104, and back to the battery 106. The repeated on and off current flow results in an average current flow through the motor, where the average current flow is related to the speed and/or acceleration of the motor. In a particular embodiment, the control circuit 102 of the control system 100 is designed such that an asserted state of the pulse-width modulated signal 116 (e.g., high voltage state) represents periods of time when the drive circuit 104 is conductive, and the non-asserted state (e.g., low or zero voltage state) represents periods of time when the drive circuit 104 is non-conductive.

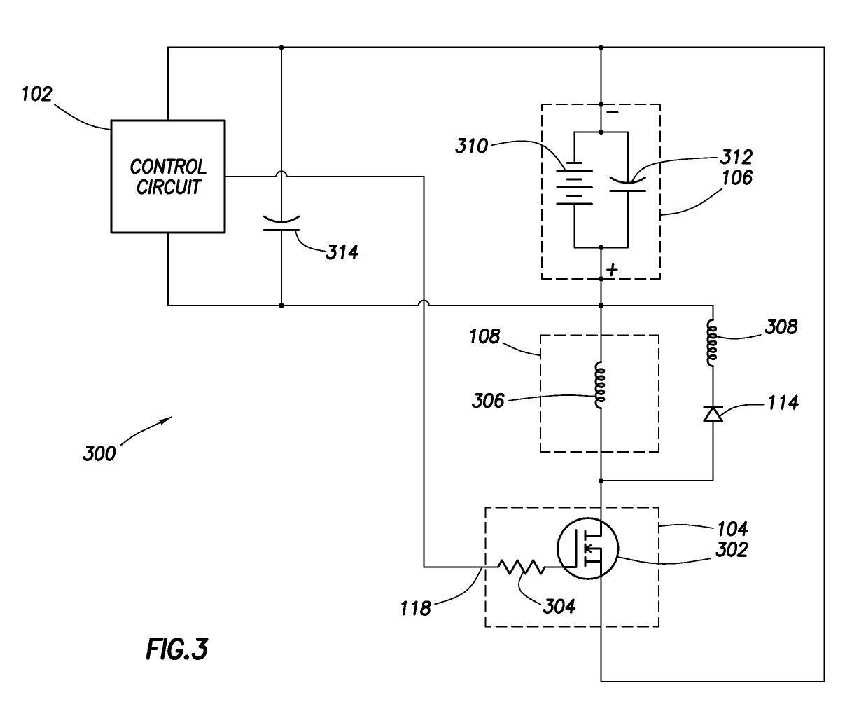

FIG. 2 shows two illustrative plots as a function of time. In particular, the upper plot 200 shows a pulse-width modulated signal 116 that may be generated by the control circuit 102 and applied the drive circuit 104, the signal to illustrate the pulse-width modulation of a particular embodiment. Four cycles of the pulse train are shown (i.e., cycles 202, 204, 206, and 208). In the illustration of FIG. 2, the frequency of the pulse train is the same, but the duty cycle of each pulse changes. For example, the pulse 210 in cycle 202 has a duty cycle of about 50%, the pulse 212 in cycle 204 has a duty cycle of about 75%, and the pulse 214 in cycle 206 has a duty cycle of about 33%. In accordance with at least some embodiments, the frequency of the pulse train is about 20 kilo-Hertz (kHz), selected in part to reduce audible noise during operation of the motor 108. Other frequencies may be equivalently used.

Still referring to FIG. 2, plot 250 shows an illustrative pulse-width modulated signal as may be generated by the control system, but shows that in some embodiments the frequency may change. In particular, plot 250 shows three cycles (i.e., cycles 252, 254, and 256). Each length of each illustrative cycle is different (in this example successively longer) with increasing time. Each pulse 258, 260 and 262 has a duty cycle, but in the illustrative example frequency of the applied pulses decreases. In some embodiments, the illustrative 20 kHz frequency discussed with respect to plot 200 is used under high load conditions (e.g., acceleration of the golf cart). While possible to use the illustrative 20 kHz frequency at all times, in accordance with at least some embodiments the frequency is lowered during low load conditions (e.g., constant speed on flat surface). Lowering the frequency of the applied pulse train reduces energy loss that occurs during transitions between conductive and non-conductive states, and as will be discussed more thoroughly below also may aid in the desulfation process for the battery 106. Before proceeding, it should be understood that the pulse trains of the plots of FIG. 2 are idealized to convey the various ideas regarding duty cycle and applied frequency. In practice, duty cycle of a pulse train on the signal line 112 would not necessarily change as quickly as the duty cycle of the pulses in FIG. 2. Likewise, frequency of applied pulse train is likely to change over the course of seconds, not necessarily pulse-to-pulse as idealized in FIG. 2.

The specification now turns to how the systems of FIG. 1 provide at least some desulfation of the battery 106. In the design of control system and circuits in accordance with techniques prior to the current specification, electrical noise is considered undesirable. As such, many techniques are implemented to reduce electrical noise. For example, an amount of time for the drive circuit 104 to change from a non-conductive state to a fully conductive state (i.e., saturated state) is increased to reduce significant voltage drops or negative spikes at the battery terminals that would otherwise be caused by the near instantaneous electrical coupling of the electrical motor 108 across the battery 106 terminals. As another example of techniques to reduce electrical noise, high frequency noise attributable to interaction of the motor 108 inherent inductance, inductance of the cabling, and the battery 106 inherent capacitance may be reduced by use of high pass filters in the circuit. Likewise in an attempt to reduce electrical noise, an amount of time for the drive circuit 104 to change from a fully conductive state (i.e., saturated state) to a non-conductive state is slowed to reduce significant voltage increases or positive spikes at the battery terminals caused by electrical current through the shorting diode 124 created by the collapsing fields associated with the inductance of the electrical motor 108 (i.e., the inductive kick of the motor).

However, the inventor of the present specification has found that electrical noise (e.g., at the battery terminals) counter intuitively provides a beneficial effect with respect to the battery 106. In particular, and as mentioned in the Background section, lead-acid batteries are subject to sulfation which adversely affects the ability of the lead-acid battery to accept a charge and produce current. However, the inventor of the present specification has found sulfation can be reduced, and to some extent reversed, by subjecting the lead-acid battery to voltage spikes, including subjecting the lead-acid battery to voltage spikes during use of the battery. More particularly, the inventor of the present specification has found that subjecting the battery to voltage spikes and other transitory electrical phenomenon (e.g., ringing caused by interaction of motor inductance and battery capacitance) aids in reducing and/or eliminating sulfation, thus resulting in significantly longer battery life.

FIG. 3 shows a motor control system 300 similar to FIG. 1, but with more detail, in order to explain various interactions which create the voltage spikes and other transitory phenomenon in accordance with various embodiments. In particular, the motor control system 300 comprises control circuit 102, drive circuit 104, battery 106, and motor 108. Drive circuit 104 is shown to comprise a single MOSFET 302 (e.g., an IRF540) along with a resistor 304 coupled between the lead 118 and the gate of the MOSFET 302. While the drive circuit 104 of FIG. 3 shows only one MOSFET, in other embodiments a plurality of MOSFETs 302 and corresponding gate resistors 304 may be equivalently used (e.g., four MOSFETs in parallel, and four resistors one each associated with each gate). Electrical motor 108 is shown as inductor 306 to illustrate the inherent inductance exhibited by an electric motor. Diode 114 is shown in series with inductor 308 to illustrate inherent inductance in the cabling of a motor control system. Battery 106 is shown as a plurality of ideal battery cells 310 in parallel with a capacitor 312 to illustrate the inherent capacitance of a battery. Finally, the control circuit 102 is coupled to the battery 108 to draw operational power, and capacitor 314 stabilizes the voltage provided to the control circuit 102.

In accordance with particular embodiments, the voltage spikes and other transitory electrical phenomenon are created, at least in part, by how quickly the drive circuit 104 transitions between a conductive and non-conductive state (i.e., rise time and fall time of the pulse-width modulated signals at the gate of illustrative MOSFET 302). In some embodiments, the rise time and fall time of signals produced by the control circuit 102 may be controlled or controllable. For example, the pulse-width modulated signal may be created by an analog output rather than a digital output such that the time to transition between states may be controlled. In other embodiments, the rise time and fall time of the pulse-width modulated signals created by the control circuit 102 are fixed, but the rise and fall times experienced at the gate of the MOSFET 302 are controlled by the value of the resistor 304 on the gate, with faster rise and fall times occurring when the value of the resistor 304 is low, and slower rise and fall times when the value of the resistor 304 is high. In accordance with at least some embodiments the value of the resistor 304 is between about 2 Ohms and 100 Ohms, and more particularly between about 5 and 10 Ohms.

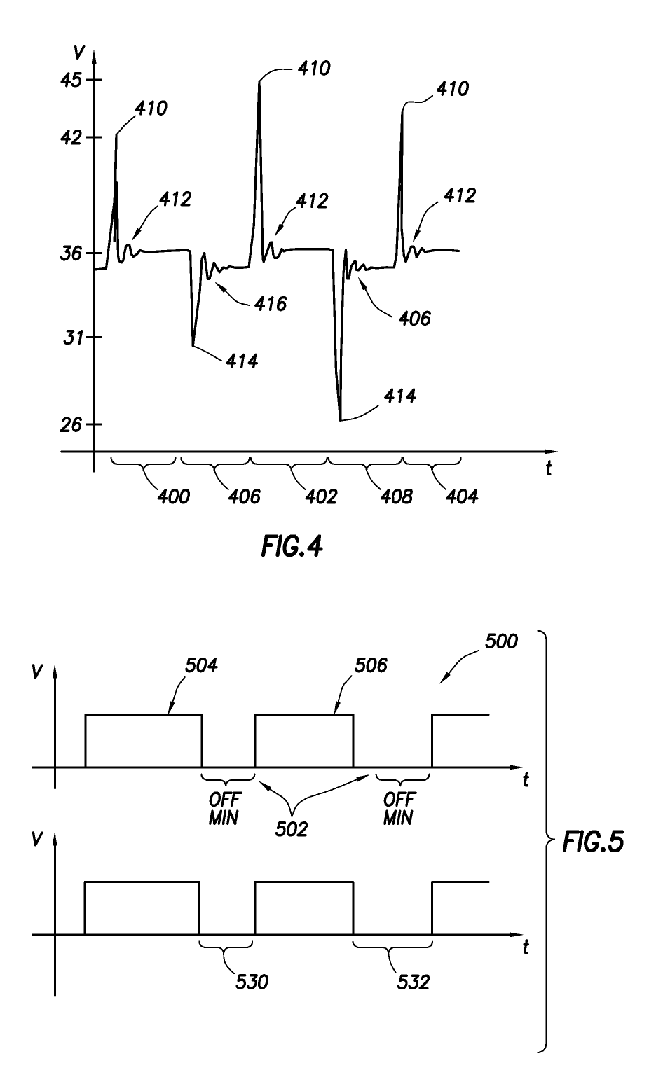

FIG. 4 shows a plot as a function of time of voltage at the battery 106 terminals for a plurality of time periods or cycles of the pulse-width modulated signal (not specifically shown) for a system similar to that of FIG. 3. In particular, periods 400, 402, and 404 show the voltage at the battery 106 terminals when the drive circuit 104 is non-conductive. Periods 406 and 408 show the voltage at the battery 106 terminals when the drive circuit 104 is conductive. During each non-conductive period, the voltage waveform shows a positive voltage spike 410, followed by a ringing 412. During each conductive period, the voltage waveform shows a negative voltage spike 414 followed by a ringing 416. Stated otherwise, the voltage spikes 410 and 414 are created contemporaneously with transitions of the voltage pulses applied to the motor.

The positive voltage spikes 410 are caused, at least in part, by the inductive kick of the motor 108 when the drive circuit 104 transitions to a non-conductive state. In particular, the electrical current produced by the collapsing fields around the inherent inductance of the motor 108 cannot flow through the drive circuit 104, and thus the electrical current flows through the shorting diode 114 back to the positive battery terminal causing the positive voltage spike 410. Related-art control systems attempt to minimize the positive voltage spikes 410 by slowing the rise/fall time of the pulse width-modulated signals applied to the drive circuit (e.g., electronically controlling at the control circuit, or increasing the resistance of the gate resistance 304). However, these large positive voltage spikes or swings aid in desulfation of the battery. In some embodiments, the positive voltage spikes cause a momentary voltage increase on the battery of at least 10% of the open-circuit battery voltage (i.e., battery voltage reaches 110% of the open circuit voltage), and in other embodiments the positive voltage spikes cause a momentary voltage increase on the battery of at least 90% of the open-circuit battery voltage (i.e., battery voltage reaches 190% of the open circuit voltage).

The negative voltage spikes 414 are caused, at least in part, by the low resistance seen across the battery terminals when the motor 108 is initially coupled by operation of the drive circuit 104. Related-art control systems attempt to minimize the negative voltage spikes 414 by slowing the rise/fall time of the pulse width-modulated signals applied to the drive circuit (e.g., electronically controlling at the control circuit, or increasing the resistance of the gate resistance 304). However, these large negative voltage spikes or swings aid in desulfation of the battery. In some embodiments, the negative voltage spikes cause a momentary voltage drop on the battery of at least 10% of the open-circuit battery voltage (i.e., battery voltage reaches 90% of the open circuit voltage), and in other embodiments the negative voltage spikes cause a momentary voltage drop on the battery of at least 90% of the open-circuit battery voltage (i.e., battery voltage reaches 10% of the open circuit voltage).

In addition to the voltage spikes 410 and 414, the battery also experiences ringing 412 and 416. The ringing 412 and 416 may be based, at least in part, on the interplay between the capacitor 314, inherent capacitance 312 of the battery, inductance 306 of the motor 108, and the inductance of the cabling represented by inductance 308. Rather than attempting to avoid such ringing 412 and 416 (e.g., by adding further filter circuits), the various embodiments utilize such ringing as a further mechanism to help in desulfation of the battery 106.

In tests conducted using a set of three lead-acid batteries coupled in series (36 volt system) with a locked-rotor DC electric motor 108 and under maximum load conditions, the positive voltage spikes 410 peaked as high as 100 Volts (decaying over about 50 mico-seconds (μs)). The ringing 412, 416 had a frequency of about 250 kHz. With the same physical set up but under minimum load conditions, the positive voltage spikes 410 peaked as high as 60 Volts (decaying over about 2 μs), and again with a ringing 412, 416 at about 250 kHz.

Further still, and though not specifically shown in FIG. 4, differences in load and motor speed result in varying duty cycle for the pulse-width modulated signal applied to the drive circuit 104, and thus the time periods between positive spikes 410 and negative spikes 414 varies with time. If follows that under changing load conditions the battery 106 experiences a variety of voltages of voltage spikes 410, 412, along with multiple ringing 414 times, and variances in time between when the spikes and ringing are present, all of which (alone or in combination) are believed to aid desulfation of the battery 106.

A least some embodiments implement minimum off times for the motor, possibly to reduce overheating of the motor because of resistive heat, and also possibly to reduce heat generated within the battery 106 while supplying positive power. FIG. 5 shows two plots as a function of time, one to illustrate the minimum off time, and the second to show a variation of the minimum off time in accordance with at least some embodiments. In particular, the upper plot of FIG. 5 shows a series of pulse-width modulated signals 500; however, there is a minimum amount of time that the signals are non-asserted, being the minimum off time 502. Thus, a particular pulse of the pulse-width modulated signal transitions to a non-asserted state to ensure the minimum off time, such as pulse 504. If speed or load on the motor is low, a pulse may transition to the non-asserted state before the minimum off time 502, as shown by pulse 506.

In accordance with particular embodiments, the minimum off time varies over time, and in some embodiments the minimum off time is unrelated to motor speed or load. The lower plot of the FIG. 5 shows such an implementation. In particular, as between two successive pulses of a pulse-width modulated signal, the minimum off time changes. Minimum off time 530 is shown the same as minimum off time 502; however, the minimum off time 532 is longer. In accordance with particular embodiments, the minimum off time is varied, some times pulse-to-pulse, and the variance is unrelated to motor speed or load. The varying of the minimum off time, however, should be such that the operator of the electric vehicle will not discern changes in acceleration or speed, and a pulse-to-pulse variance achieves the criteria. In some cases the variance is random or pseudo random. The net effect is that the application of the voltage spikes and ringing discussed above are further varied by the changes in the minimum off time.

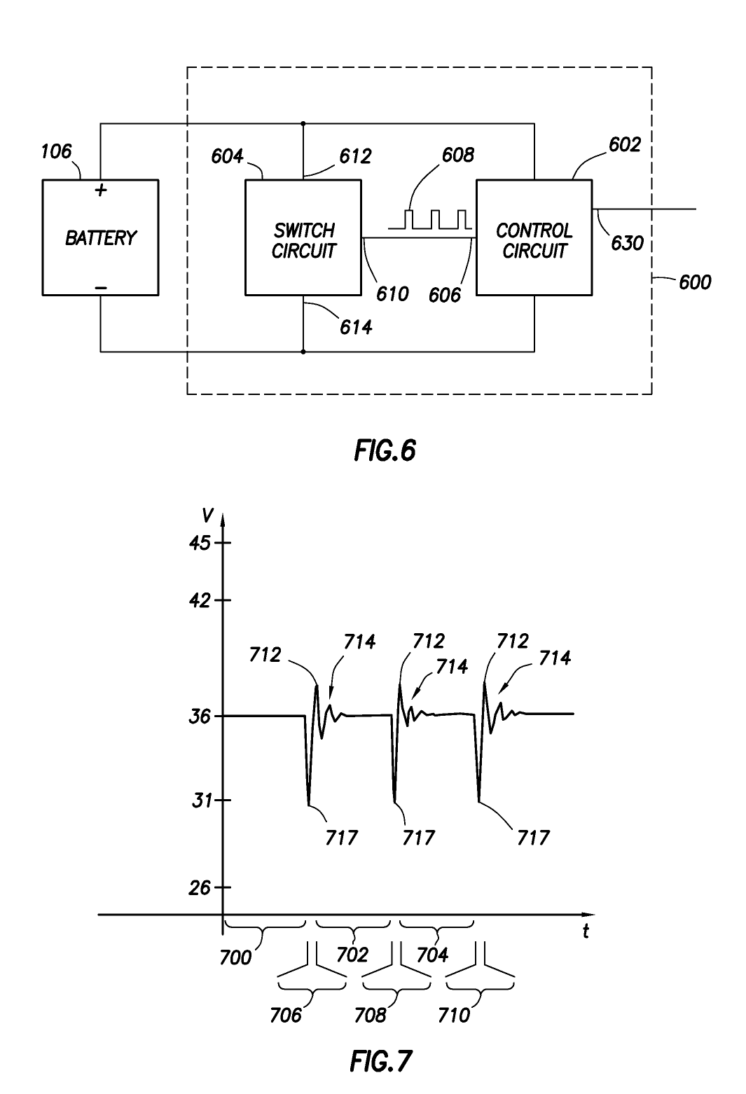

The various voltage spikes and other electrical phenomenon discussed above are created, at least in part, by operation and interplay of the various elements of FIGS. 1 and 3; however, in yet still other embodiments the voltage spikes and various other electrical phenomenon may be created by a separate and independent set of circuit elements. FIG. 6 shows a schematic diagram of a system to induce voltage spikes and ringing in accordance with further embodiments. In particular, the control system 600 comprises a control circuit 602 and a switch circuit 604 coupled to a battery 106. The battery 106 may also be coupled to another control system, such as a control system to control speed of wheeled vehicle. In other cases, the battery 106 may coupled to the control system 600 alone. In operation, the switch circuit 604 periodically causes a short circuit across the leads of the battery 106.

In the illustrated embodiments, the control circuit 602 draws operational power from battery 106. In other cases, the control circuit 602 may draw power from another source, such as a wall socket or internal battery. The control circuit 602 defines an output lead 606 upon which is driven a pulsed output signal 608. In accordance with particular embodiments, the control circuit 602 drives an asserted state on the pulsed output signal 608 at least once per second, and in some cases the pulsed output signal 608 is asserted at a frequency of 350 Hz (i.e., asserted about every 2.8 mS). The asserted state of the pulsed output signal 608 may remain asserted for between and including 1 to 5 micro-seconds (μS), and in a particular case for about 2 μS.

Control circuit 602 may take many forms. In some embodiments the control circuit 602 is an analog control circuit, where control signals sent to the switch circuit 604 are generated by discrete components. In other embodiments, the control circuit 602 is a processor, application specific integrated circuit (ASIC), or microcontroller executing a program. The program, when executed, creates one or more output signals which are provided to the switch circuit 604. In yet still other embodiments, combinations of processor-based control and analog-based control are used.

Switch circuit 604 defines a control input lead 610, as well as a first lead 612 and a second lead 614, where the leads are coupled to the terminals of the battery 106. As shown the control input lead 610 couples to the output lead 606, and thus the pulsed output signal 608. In some embodiments, the switch circuit 604 comprises one or more metal oxide semiconductor field effect transistors (MOSFETs). The specific type and number of such MOSFETs depends on a variety of factors, such as the peak shorting current and the switching frequency. For standalone desulfation, a single N-Channel MOSFETs having part number IRF540 provides sufficient current carrying capability. However, greater or fewer MOSFETs, different types of MOSFETs, different types of transistors (e.g., junction transistors) may be equivalently used.

In accordance with particular embodiments, switching circuit 604 is alternately driven between a fully-saturated conductive state and non-conductive state responsive to the pulsed output signal 608 applied to the control lead 610. During periods of time when the switch circuit 604 is conductive, an effective short circuit across the battery 106 terminals is present, resulting in electrical current flow through the switch circuit 604 and back to the battery 106. In a particular embodiment, the control circuit 602 of the control system 600 is designed such that an asserted state of the pulsed output signal 608 represents periods of time when the switch circuit 604 is conductive, and the non-asserted state represents periods of time when the drive circuit 104 is non-conductive.

The specification now turns to how the systems of FIG. 6 provide at least some desulfation of the battery 106. Related-art systems that purport to facilitate desulfation of batteries apply a positive voltage spike to the battery terminals. That is, a small amount of energy is taken from the battery, and then supplied back to the battery in the form of increased voltage (measured at the positive terminal referenced to the negative terminal). However, the inventor of the present specification has found momentary short circuits, while creating voltage spikes, also creating voltage oscillations (i.e., ringing) that provides a beneficial effect with respect to the battery 106. In particular, the inventor of the present specification has found sulfation can be reduced, and to some extent reversed, by subjecting the lead-acid battery to voltage spikes caused by momentary shorts as well as the ringing that follows. Such voltage spikes and ringing aids in reducing and/or eliminating sulfation, thus resulting in significantly longer battery life.

FIG. 7 shows a plot as a function of time of voltage at the battery 106 terminals for a plurality of short circuits (applied by the switch circuit 604 responsive to the pulsed output signal 608), in accordance with at least some embodiments. In particular, periods 700, 702, and 704 show the voltage at the battery 106 terminals when the switch circuit 604 is non-conductive. Periods 706, 708, and 710 show the voltage at the battery 106 terminals when the switch circuit 604 is conductive. During each non-conductive period following a conductive period, the voltage waveform shows a positive voltage spike 712, followed by a ringing 714. During each conductive period, the voltage waveform shows a negative voltage spike 717. In some cases the lengths of the non-conductive periods 700, 702, and 704 are one second or less, and in a particular case the non-conductive periods are 2.8 mS. In a particular embodiment the conductive periods 706, 708, and 710 are between and including 1 to 5 μS, and in some cases 2 μS. The relative sizes of the periods in FIG. 7 may not accurately reflect the relationship between the lengths of time of conductive and non-conductive states, so as to make the figure more readable.

The negative voltage spikes 717 are caused the short circuit presented by switch circuit 604 during conductive periods, and may be attributable to a lag time in the chemical process of creating electrical current by a lead-acid battery. In some embodiments, the switch circuit 604 and the width of the pulses of the pulsed output signal 608 are designed such that the electrical current drawn by the short circuit of the switch circuit 604 is at least 150 Amps peak, and in a particular case at least 200 Amps. Other amperages may be equivalently used if the ringing 714 is created by the battery 106 (as discussed more below). In addition to the voltage spikes 712 and 717, the battery also experiences ringing 714. The ringing 714 in accordance with at least some embodiments has a frequency at least 1 Mega-Hertz (MHz), and in a particular case between and including 2 to 4 MHz, and may last on the order of about 15 μS. The inventor of the present specification has found that the ringing 714 in the ranges discussed above is different than an oscillation frequency predicted for the circuit, where the predicted oscillation frequency takes into account the inductance and capacitance of the control circuit 600 and battery 106. More particularly, the ringing 714 in the range discussed above is in many cases well above an expected oscillation frequency. Although not tying operation of the various embodiments to a particular physical phenomenon, it is believed that the ringing 714 above the 1 MHz range, and particularly in the 2 to 4 MHz range, is caused by the natural oscillation frequency of crystallized sulfate on the battery 106 plates.

Returning to FIG. 6, the control system 600 may be used simultaneously with a separate control system, such as control system 100 controlling speed of wheeled vehicle, or as a standalone device. However, the electronics of some control systems that control speed of wheeled vehicles are particularly susceptible to noise on the battery terminals (another reason such systems work to reduce noise in spite of the beneficial effect with respect to sulfate removal), and such systems may not operate properly when a control system 600 is used in parallel. In such cases, the control circuit 602 may suspend the pulsed output signal 608 (and thus suspend the periodic short circuits) when the wheeled vehicle is in motion. The control circuit 602 may make a determination as to the state of the wheeled vehicle by any suitable mechanism. For example, the control circuit 602 may monitor battery 106 voltage, and view a reduced battery voltage as an indication that the battery 106 is supplying power to load such as a DC electric motor. In other cases, the control circuit 602 may define an input lead 630 which directly receives an indication that desulfation should be suspended. For example, the control system which controls speed of the wheeled vehicle may produce a Boolean signal applied to the input lead 630 to inform the control circuit 602 to suspend the pulsed output signal 608. In a particular embodiment, the input lead 630 of the control circuit 602 may couple in parallel to the accelerator of the wheeled vehicle, and thus may suspend desulfation when the accelerator is depressed.

It is noted that the functions of the control circuit 602, and the control circuit 102, have substantial overlapping functions, particularly in cases where the control circuit 602 defines the input lead 630. For example, the pulse output signal 608 could be considered a pulse-width modulated signal at a constant duty cycle and frequency. Thus, in other embodiments the control circuit 602 and control circuit 102 may be the same circuit, with the differences implemented as switch setting or perhaps execution of a different program by the processor in processor-based control systems.

It is theorized that the voltage spikes and other transitory electrical phenomenon applied at the battery terminals result in better desulfation because of the interplay of the chemical reactions and the physical forces within a battery. For example, during use the electrodes of the battery are subject to physical deflection (either because of electrical forces, physical vibration, or both), and such physical deflection combined with applying transitory voltage spikes aids in physically detaching the sulfate and/or sulfate crystals from the surface of the electrodes, thus freeing the surface for the chemical reactions associated with charge and discharge of a lead acid battery. Based on experimentation regarding degradation of lead-acid battery performance with related-art control systems and control systems constructed in accordance with the various embodiments, a lead-acid battery life of eight years or more is possible. Although the combination of the physical and electrical interaction is believed to cause the beneficial effect, the development of other physical, electrical and/or chemical theories which explain, or better explain, the benefits shall not negate the patentability or enforceability of this patent.

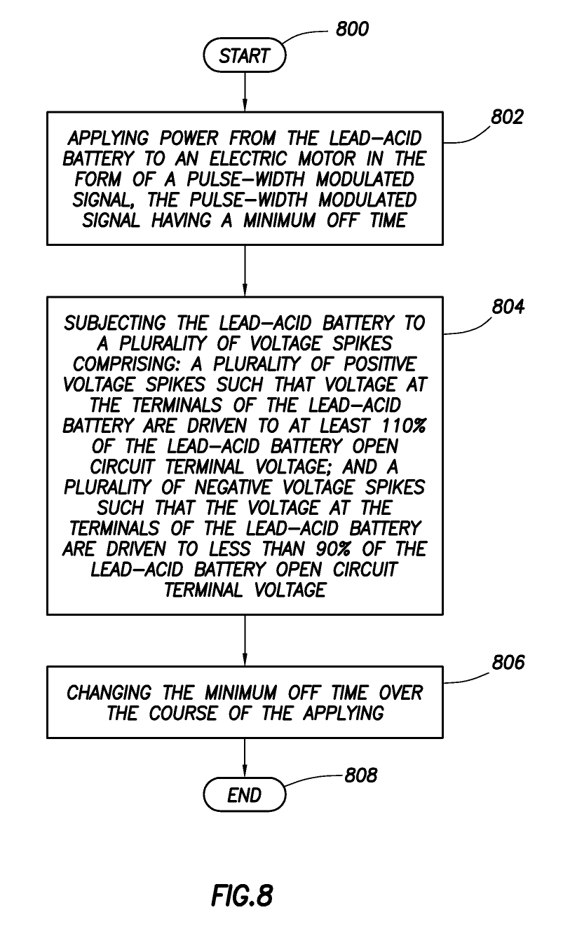

FIG. 8 shows a method of reducing sulfate buildup in accordance with at least some embodiments. In particular, the method starts (block 800) and comprises: applying power from the lead-acid battery to an electric motor in the form of a pulse-width modulated signal, the pulse-width modulated signal having a minimum off time (block 802); and during the applying subjecting the lead-acid battery to a plurality of voltage spikes (block 804); and changing the minimum off time over the course of the applying (block 806). The voltage spikes may comprise: a plurality of positive voltage spikes such that voltage at the terminals of the lead-acid battery are driven to at least 110% of the lead-acid battery open circuit terminal voltage; and a plurality of negative voltage spikes such that the voltage at the terminals of the lead-acid battery are driven to less than 90% of the lead-acid battery open circuit terminal voltage. Thereafter the method ends (block 808).

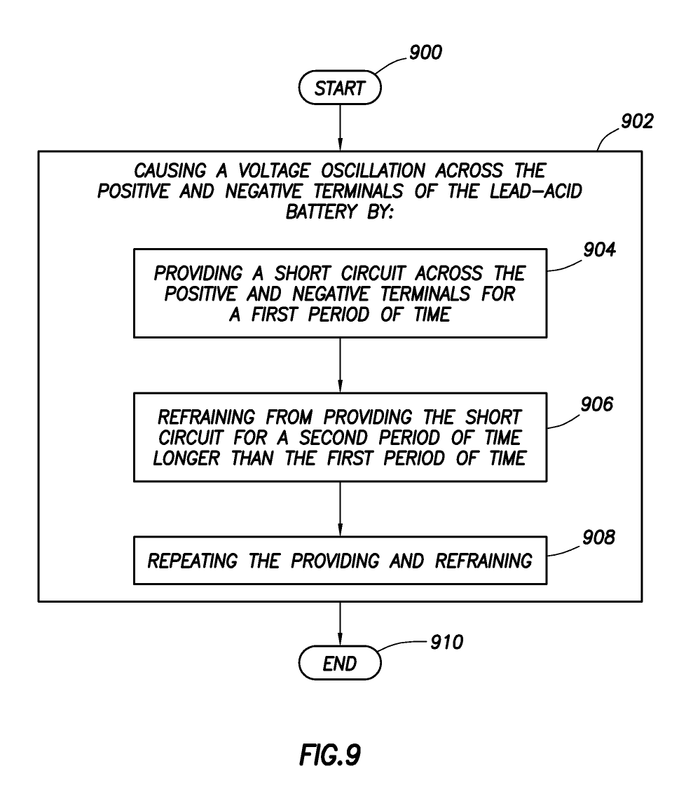

FIG. 9 shows a method in accordance with at least some embodiments. In particular, the method starts (block 900) and comprises causing a voltage oscillation across the positive and negative terminals of a lead-acid battery (block 902). Causing voltage oscillations may be by: providing a short circuit across the positive and negative terminals for a first period of time (block 904); refraining from providing the short circuit for a second period of time longer than the first period of time (block 906); and repeating the providing and refraining (block 908). Thereafter, the method ends (block 910).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A direct-current (DC) electric motor control system comprising:
a control circuit comprising:
an input lead that accepts a desired speed indication; and
an output lead upon which is driven a pulse-width modulated output signal responsive to the desired speed indication;
wherein the control circuit implements a minimum off time within each cycle of the pulse-width-modulated signal;
a drive circuit coupled to the output lead of the control circuit, the drive circuit alternates between a conductive state and a non-conductive state responsive to the pulse-width modulated output signal;
wherein the control system is configured such that transition time between a conductive state of the drive circuit and an immediately subsequent non-conductive state of the drive circuit induces a voltage rise on a battery coupled to a DC electric motor, the voltage spike having a peak voltage of at least 10% of the open-circuit battery voltage;
wherein the control system is configured such that an amount of time between a non-conductive state of the drive circuit and an immediately subsequent conductive state of the drive circuit induces a voltage drop on the battery at least 10% of the open-circuit battery voltage; and
wherein the control circuit varies the minimum off time.

2. The system of claim 1 wherein the control circuit varies the minimum off time at least once per minute during use.

3. The system of claim 1 wherein the control circuit increases the minimum off time as load on the motor increases load on the motor.

4. The system of claim 1 wherein the transition time between the conductive and non-conductive state is controlled, at least in part, by a transition time of the pulse-width modulated signal between a non-asserted state and an asserted state.

5. The system of claim 1 wherein the transition time between the non-conductive and conductive state is controlled, at least in part, by a transition time of the pulse-width modulated signal between an asserted state and a non-asserted state.

6. The system of claim 1 further comprising:
a resistor coupled in series between the control circuit and the drive circuit;
wherein the transition times are controlled, at least in part, the resistance of the resistor.

7. The system of claim 1 wherein the control circuit varies a frequency of the pulse-width modulated output signal proportional to speed.

8. The system of claim 7 wherein the control circuit varies the frequency of the pulse-width modulated output signal inversely proportional to speed.

9. The system of claim 1 wherein the voltage rise on the battery caused by a transition from a conductive state to a non-conductive state of the drive circuit induces a voltage rise of at least 90% of the open-circuit battery voltage.

10. The system of claim 1 wherein the voltage drop on the battery caused by a transition from a non-conductive state to a conductive state of the drive circuit induces a voltage drop of at least 90% of the open-circuit battery voltage.

11. A system comprising:
a control circuit that creates an output signal that alternates between and asserted state and a non-asserted state;
a switch circuit that defines a control lead, a first lead, and a second lead, the control lead coupled to the output signal of the control circuit, and the first and second leads configured to couple between the positive and negative terminals, respectively, of a lead-acid battery;
wherein the first and second leads of the switch circuit alternate between a conductive state and a non-conductive state responsive to the asserted state and non-asserted state, respectively, of the output signal;
wherein when in the conductive state the switch circuit provides a short circuit across the positive and negative terminals of the lead acid battery.

12. The system of claim 11 wherein the control circuit drives an asserted state of the output signal at least once per second.

13. The system of claim 12 wherein the control circuit drives an asserted state of the output signal once every 10 milli-seconds.

14. The system of claim 11 wherein the control circuit drives the asserted state for between and including 1 to 5 milli-seconds.

15. The system of claim 14 wherein the control circuit drives the asserted state for 5 milli-seconds.

16. The system of claim 11 wherein the control circuit refrains from driving an asserted state on the output signal when power is being supplied from the lead-acid battery to a load distinct from the control circuit and the switch circuit.

17. The system of claim 11 wherein the control circuit drives the asserted state for a period of time sufficient to conduct at least 150 Amps through the switch circuit.

18. The system of claim 17 wherein the control circuit drives the asserted state for a period of time sufficient to conduct at least 200 Amps through the switch circuit.

19. A method of reducing sulfate buildup on the plates of a lead-acid battery, the method comprising:
applying power from the lead-acid battery to an electric motor in the form of a pulse-width modulated signal, the pulse-width modulated signal having a minimum off time; and during the applying
subjecting the lead-acid battery to a plurality of voltage spikes comprising:
a plurality of positive voltage spikes such that voltage at the terminals of the lead-acid battery are driven to at least 110% of the lead-acid battery open circuit terminal voltage; and
a plurality of negative voltage spikes such that the voltage at the terminals of the lead-acid battery are driven to less than 90% of the lead-acid battery open circuit terminal voltage;
changing the minimum off time over the course of the applying.

20. The method of claim 19 wherein changing the minimum off time further comprises changing the minimum off time at least once per minute.

21. The method of claim 19 wherein changing the minimum off time further comprises increasing the minimum off as load on the motor increases.

22. The method of claim 19 wherein subjecting the lead-acid battery to a plurality of voltage spikes further comprises a plurality of positive voltage spikes such that voltage at the terminals of the lead-acid battery are driven to at least 190% of the lead-acid battery open circuit terminal voltage.

23. The method of claim 19 wherein subjecting the lead-acid battery to a plurality of voltage spikes further comprises a plurality of positive voltage spikes such that voltage at the terminals of the lead-acid battery are driven to at least 10% of the lead-acid battery open circuit terminal voltage.

24. The method of claim 19 wherein applying power further comprises applying power from the lead-acid battery comprising three individual batteries connected in series, with each individual battery having six cells.

25. The method of claim 19 wherein subjecting further comprises changing the frequency of voltage pulses supplied to the electric motor.

26. The method of claim 19 wherein applying power further comprises applying power to the electric motor propelling a wheeled vehicle.

27. The method of claim 26 wherein applying power further comprises applying power to the electric motor propelling a golf cart.

28. A method comprising:
causing a voltage oscillation across the positive and negative terminals of a lead-acid battery by:
providing a short circuit across the positive and negative terminals for a first period of time; and then
refraining from providing the short circuit for a second period of time longer than the first period of time; and
repeating the providing and refraining.

29. The method of claim 28 wherein causing further comprises causing the voltage oscillation that has a frequency at least 1 Mega-Hertz (MHz).

30. The method of claim 29 wherein causing further comprises causing the voltage oscillation that has a frequency of between and including 2 to 4 MHz.

31. The method of claim 28 wherein a frequency of the voltage oscillation is different than an oscillation frequency predicted that takes into account the inductance and capacitance of a circuit coupled to the lead-acid battery.

32. The method of claim 28 wherein providing the short circuit further comprises providing the short circuit for between and including 1 to 5 micro-seconds.

33. The method of claim 28 wherein repeating further comprises repeating once every 2.8 milli-seconds.
